(19) United States
(12) Patent Application Publication
(10) Pub. No.: US 2003/0167027 A1
(43) Pub. Date: Sep. 4, 2003

(54) Massager for the scalp in the shape of a cap or alike

(76) Inventors: Elisiario Ferreira Estrella, Araraquara (BR); Murilo Ramos de Almeida Hallgren, Araraquara (BR)

Correspondence Address: WATOV & KIPNES, P.C., P.O. Box 247, Princeton Junction, NJ, 08550, US

(21) Appl. No.: 10/341,131

(22) Filed: Jan. 13, 2003

(30) Foreign Application Priority Data
Mar. 1, 2002 (BR) PI0200825-4

(51) Int. Cl. A61H 7/00

(52) U.S. Cl. 601/136; 601/70

(57) ABSTRACT

“MASSAGER FOR THE SCALP IN THE SHAPE OF A CAP OR ALIKE”, which applies to all and every cap or alike to be worn on the head (1) apparently conventional, and which can, obviously, be manufactured using different fabrics consisting of the inclusion, in the inner aspect of the cap or alike (1), of a flexible mesh (2), with the approximate pattern of a grid, whose openings could vary as needed, said flexible mesh follows the anatomical contour of the cap or alike (1) and it has, throughout its extension, a plurality of small half-sphere caps (3) that are set on the scalp; over the referred flexible mesh (2) is set the vibration mechanism (4), of minute dimensions, and which is set in between this said mesh (2) and the bottom of the cap (1) or alike, referred vibration mechanism (4) comprising an electric motor (5) fed by battery or alike (6), whose axis (7) receives an eccentric mass (8) which acts, upon contact, against the surface of the referred flexible mesh (2) thus providing the vibration.

The present Patent of Invention request refers to a innovative massager for the scalp in the shape of a cap or alike, notably of a cap that stands out for its individual and original constructive and utilitarian characteristics, entirely innovative in the technical sector of capillary massaging, with significant and extraordinary advantages intended for users in general, particularly those affected by the problems of baldness, which is currently present in a wide range of the adult population.

Baldness is, in this day and age, a problem affecting a great portion of the population worldwide. In many cases, baldness can be even ignored by its carriers, who end up accepting it naturally, with no prejudice, and sometimes, even with plenty of good humor.

However, we believe that the great majority of people is uncomfortable with their baldness, ending up trying to disguise it in different ways, either by means of wigs, implants, or other treatments or methods, many of which make baldness even more evident; and worst of all is the concern in hiding it or eliminating it.

According to the literature and medicine itself, the main cause of baldness is the reduction of blood flow in the upper part of the head. This is yet reinforced by the fact that a great number of bald people presents baldness only in the upper part of their heads, while the side practically always retains a considerable portion of hair, also largely used as a donation area for implants.

The inventor has also verified that the natural movement of the jaw creates, by means of its alternate displacement, a natural stimulation to blood flow in the side area of the head, such procedure being highly positive for the conservation of hair in this area.

In view of these aspects, the inventor sought out a way to stimulate, in a similar manner, the blood flow in the upper area of the head, with the objective to avoid the reduction of hair in this area, in people with a tendency to become bald.

It is well known that the technique of capillary massage is recognized and has been proven effective. Nonetheless, its attainment depends on several factors, such as time, and the natural absence of practicality that discourages the user due to the fact that such procedure should be performed by a professional in the area, which besides being costly, it involves the need of free time, which is becoming ever more scarce, notably in the big cities where the exceedingly troubled way of life always places activities of such nature in second place.

The practical way found by the inventor consists in promoting, by means of a cap with unique characteristics, the massaging of the upper area of the head. An important aspect is that such procedure does not require any effort or naturally undesirable options from the user, whatsoever, since it is limited to the use of a cap.

Thus, the referred cap is set, in its inner aspect, with a specific flexible mesh supplied with small half-sphere caps, such a mesh able to be activated by a minute mechanism embedded above it, in such a way as to provide it with a vibration in a predetermined frequency. When in contact with the upper part of the head, this flexible mesh promotes the massaging that stimulates the blood flow in this area, consequently strengthening the hair tissue, thus avoiding hair from being gradually reduced.

On the other hand, since it consists of an apparently normal cap, with portable equipment, it offers the user total mobility, as well as freedom to practice other activities, being able to wear the cap while driving, walking, at the office, in public places, etc.

The invention is hereby explained with reference to the enclosed drawings, in which the following are represented:

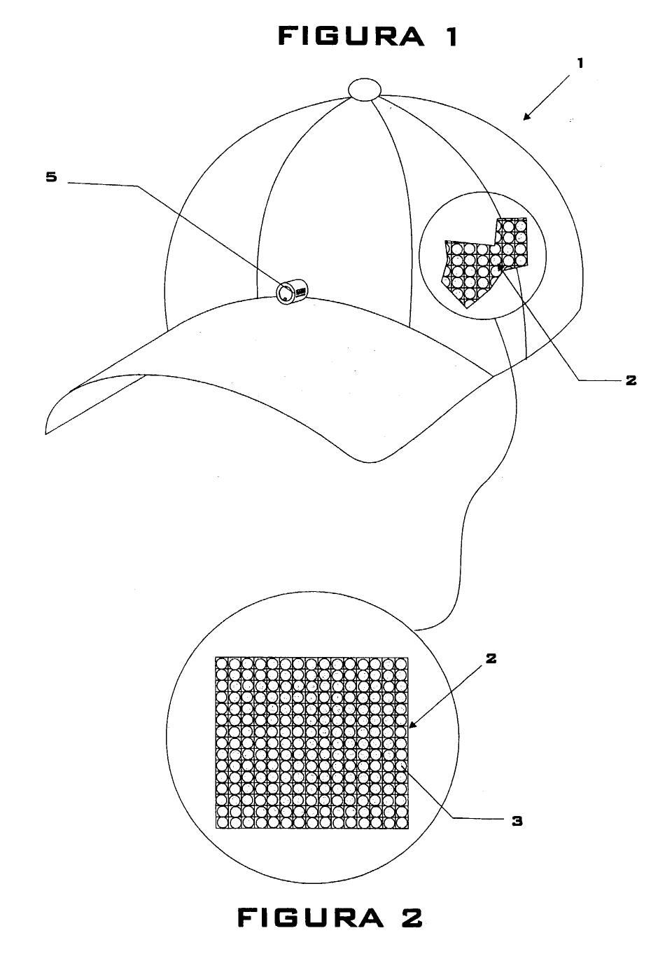

FIG. 1: A perspective view of a cap illustrating the position of the flexible mesh and the vibration mechanism;

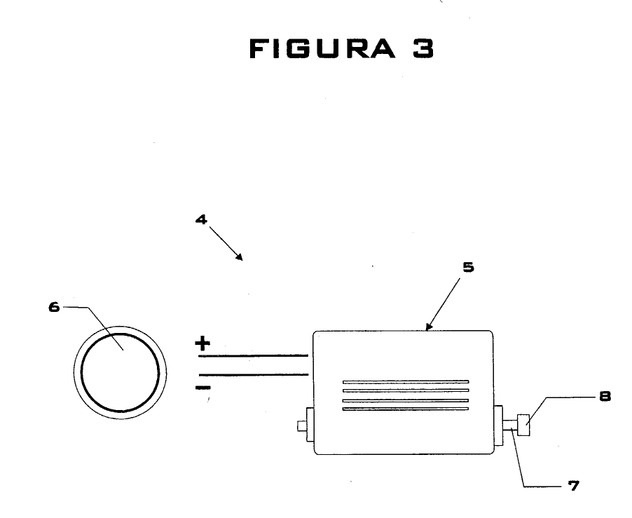

FIG. 2: Enlarged detail of the flexible mesh;

FIG. 3: Detail of the vibration mechanism.

The massager for the scalp in the shape of a cap or alike, object of the hereby Patent of Invention request, applies to all and every cap or alike to be worn on the head (1) apparently conventional, and which can, obviously, be manufactured using different fabrics.

The massager itself consists of the inclusion, in the inner aspect of the cap or alike (1), of a flexible mesh (2), with the approximate pattern of a grid, whose openings could vary as needed, said flexible mesh follows the anatomical contour of the cap or alike (1) and it has, throughout its extension, a plurality of small half-sphere caps (3) that are set on the scalp.

Over the referred flexible mesh (2) is set the vibration mechanism (4), of minute dimensions, and which is set in between this said mesh (2) and the bottom of the cap (1) or alike, referred vibration mechanism (4) comprising an electric motor (5) fed by battery or alike (6), whose axis (7) receives an eccentric mass (8) which acts, upon contact, against the surface of the referred flexible mesh (2) thus providing the vibration.

In this fashion., the present massager for the scalp can be worn without other people noticing its operation and performance, as it is “camouflaged” in the shape of a cap or alike.

Notwithstanding, this massager shall be extremely worthy not only to people who are already facing the process of gradual reduction of hair, but also to the people who, due to familiar history, are naturally subject to a process of premature baldness.

As stated earlier, the movement of the flexible mesh and, consequently, of the soft half-sphere caps (3) against the scalp determines a massaging that stimulates the blood flow in the area, strengthening the hair tissue thus discouraging hair from being precociously reduced.

1) “MASSAGER FOR THE SCALP IN THE SHAPE OF A CAP OR ALIKE”, which applies to all and every cap or alike to be worn on the head (1) apparently conventional, and which can, obviously, be manufactured using different fabrics characterized by the inclusion, in the inner aspect of the cap or alike (1), of a flexible mesh (2), with the approximate pattern of a grid, whose openings could vary as needed, said flexible mesh follows the anatomical contour of the cap or alike (1) and it has, throughout its extension, a plurality of small half-sphere caps (3) that are set on the scalp; over the referred flexible mesh (2) is set the vibration mechanism (4), of minute dimensions, and which is set in between this referred mesh (2) and the bottom of the cap (1) or alike, referred vibration mechanism (4) comprising an electric motor (5) fed by battery or alike (6), whose axis (7) receives an eccentric mass (8) which acts, upon contact, against the surface of the referred flexible mesh (2) thus providing the vibration.
